(19) United States
(12) Patent Application Publication
(10) Pub. No.: US 2026/0178935 A1
(43) Pub. Date: Jun. 25, 2026

(54) COLLABORATIVE RECLASSIFICATION OF DATA PROCESSING SYSTEMS BASED ON KNOWLEDGE GRAPHS

(71) Applicant: Dell Products L.P., Round Rock, TX (US)

(72) Inventors: ASHOK NARAYANAN POTTI, Bangalore (IN); TSEHSIN JASON LIU, Wellesley, MA (US); ZIJIA WANG, London (GB); DALE WANG, Hayward, CA (US); MIN GONG, Shanghai (CN)

(21) Appl. No.: 18/989,995

(22) Filed: Dec. 20, 2024

(51) Int. Cl. G06N 5/022

(52) U.S. Cl. CPC G06N 5/022

(57) ABSTRACT

Methods and systems for managing operation of a distributed system of data processing systems are disclosed. The operation may be managed by identifying that a data processing system has drifted from an original state. The identification may be made using at least one agent hosted by the data processing system and based on a knowledge graph. Once identified, at least one other data processing system may be identified that may be similar to the data processing system based on a similarity map. The data processing system may collaboratively, between the data processing system and the at least one other data processing system, be reclassified to a different similarity group. The data processing system may subsequently perform a management process using the different similarity group.

### FIELD

Embodiments disclosed herein relate generally to managing operation of a distributed system comprising data processing systems. More particularly, embodiments disclosed herein relate to collaboratively classifying data processing systems through similarity analysis.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2B show data flow diagrams in accordance with an embodiment.

FIGS. 2C-2D show interaction diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a distributed system comprising data processing systems. The data processing systems may operate in a computing infrastructure that may be managed with and/or without a central processing entity. To do so, a data processing system of the data processing systems may be classified as a member of a similarity group of a plurality of similarity groups.

Each data processing system of the data processing systems may maintain a copy of a knowledge graph of a condition of the distributed system and/or a copy of a similarity map that defines at least a portion of the plurality of similarity groups. Based on at least the knowledge group, a data processing system may be identified to have drifted from an original state (e.g., the original state used as a basis for classifying the data processing system as a member of the similarity group).

To make the identification, operation of the data processing system may be monitored using a first agent hosted by the data processing system to make an initial conclusion that the data processing system has drifted from the original state. The initial conclusion may subsequently be collaboratively verified by the first agent and at least one other agent hosted by another of the data processing systems. The other data processing system may be selected based on a copy of the similarity map maintained by the data processing system.

Once identified, the data processing system may be reclassified with respect to the plurality of similarity groups into a different similarity group based on a new state of the data processing systems. To reclassify the data processing system, a first agent hosted by the data processing system may collaboratively, with a second agent hosted by a second data processing system, analyze the new state of the data processing system to obtain an analysis result. Based on at least the analysis result, clusters of data processing systems may be updated to place the data processing system into a different similarity group.

While operating in the different similarity group, a management process may be performed to update operation of the data processing system to facilitate provisioning of desired computer-implemented services.

Thus, embodiments disclosed herein may provide an improved method for managing operation of a distributed system comprising data processing systems. By collaboratively, using agents and/or knowledge graphs hosted by the data processing systems, reclassifying a data processing system into a new similarity group when the data processing system has drifted from an original state, the data processing system may provide desired computer-implemented services while operating in the new similarity group.

In an embodiment, a method for managing operation of a distributed system comprising data processing systems is provided. The method may include: (i) making an identification that a data processing system of the data processing systems has drifted from an original state used as a basis for classifying the data processing system as a member of a similarity group of a plurality of similarity groups; (ii) based on the identification: (a) reclassifying the data processing system with respect to the plurality of similarity groups into a different similarity group of the plurality of similarity groups based on a new state of the data processing system due to the drifting of the data processing system; and (b) performing a management process for the data processing system using the different similarity group to update operation of the data processing system to place the data processing system into a new operation state to facilitate provisioning of computer-implemented services.

Each of the data processing systems may maintain a copy of a knowledge graph of a condition of the distributed system, each knowledge graph being a local view of the distributed system.

Each of the data processing systems may exchange information with neighboring data processing systems to construct respective copies of the knowledge graph.

Each of the data processing systems may maintain a copy of a similarity map that defines at least a portion of the plurality of similarity groups, each similarity map being a local view of a similarity between the data processing systems.

Making the identification may include: (i) monitoring, by a first agent hosted by the data processing system, operation of the data processing system to make an initial conclusion that the data processing system has drifted from the original state; and (ii) collaboratively, by the first agent and with at least one other agent hosted by another of the data processing systems selected on a basis of a copy of the similarity map maintained by the data processing system, verifying the initial conclusion to make the identification.

Making the identification may include prompting a trained machine learning model based on at least a portion of the knowledge graph.

Reclassifying the data processing system with respect to the plurality of similarity groups into the different similarity group of the plurality of similarity groups based on the new state of the data processing system due to the drifting of the data processing system may include: (i) collaboratively, by at least a first agent hosted by the data processing system and another agent hosted by another of the data processing systems selected on a basis of a copy of the similarity map maintained by the data processing system, analyzing the new state of the data processing system to obtain an analysis result; and (ii) updating clusters of the data processing systems based on the analysis result to place the data processing system into the different similarity group.

Performing the management process may include: (i) identifying a level of autonomy for an operation to be performed by the data processing system; (ii) identifying at least one other data processing system based on the different similarity group and the level of autonomy; (iii) collaboratively, by the data processing system and the at least one other data processing system, identifying a process for performing the operation to be performed by the data processing system; and (iv) initiating, by the data processing system, performance of the process to update the operation of the data processing system.

The data processing system may be an edge device among edge devices within a computing infrastructure comprising a centralized processing entity tasked with managing operation of the edge devices, the data processing system being configured to perform the method without interference from the centralized processing entity if the data processing system comprises sufficient computing resources to perform the method.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

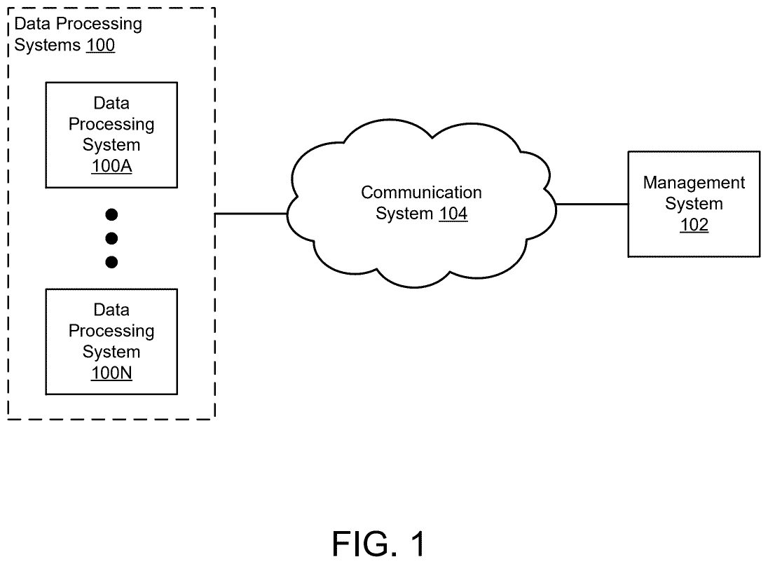

Turning to FIG. 1, a block diagram illustrating a system in accordance with an embodiment is shown. The system shown in FIG. 1 may provide any type and quantity of computer-implemented services (e.g., to user of the system and/or devices operably connected to the system).

The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1). Other types of computer-implemented services may be provided by the system shown in FIG. 1 without departing from embodiments disclosed herein.

The system may include data processing systems 100. Each data processing system (e.g., 100A, 100B, etc.) may provide similar and/or different computer-implemented services, and may provide the computer-implemented services independently and/or in cooperation with other data processing systems. Data processing systems 100 may include edge devices (e.g., located at the edge of a computing infrastructure) that may, for example, generate local data, host various resources, and/or perform any other functionality.

Due to computational limitations of a given data processing system, data (e.g., telemetry data, operational data, etc.) may be generated by each data processing system and provided to a management system that may configured as a centralized processing entity. The management system may, for example, perform data processing, model training, system deployment, inference generation, and/or perform any other actions to manage operation of the data processing systems. However, such processing by the management system may be negatively impacted by poor network connectivity, packet losses during transfer, expensive data transmission costs, and/or other such limitations.

Because data processing systems 100 may each host computing resources (e.g., hardware resources, software resources, etc.) capable of providing at least a portion of the computer-implemented services, data processing systems 100 may collaborate (e.g., communicate, share data, etc.) to perform actions relevant to updating operation of data processing systems 100. To collaborate, data processing systems 100 may be organized into any number and/or type of similarity groups. The similarity groups may be based on, for example, operating states, types of service provided, a physical location, and/or any other qualities of data processing systems 100.

However, a data processing system may drift from an original state of operation of the data processing system used as a basis for classifying the data processing system as a member of a similarity group. For example, the data processing system may be classified in the similarity group based on a similar workload, configuration, performance metrics, etc. While operating, the data processing system may drift from the original state by reducing and/or modifying its workload, configuration, etc. As such, the data processing system may be underutilized and/or demonstrate reduced performance when compared to other data processing systems in the similarity group.

To improve a likelihood that a data processing system may provide desired computer-implemented services, operation of the data processing system may be updated using a different similarity group to place the data processing system into a new operation state to facilitate provisioning of desired computer-implemented services. To do so, a data processing system may identify that the data processing system has drifted from an original state.

The data processing system may maintain a copy of a knowledge graph of a condition of the system (e.g., a local view of a distributed system based on operational data of a portion of data processing systems in a distributed system). The knowledge graph may be constructed based on information exchanged between the data processing system and neighboring data processing systems (e.g., other data processing systems in a similarity group). The knowledge graph may include nodes and edges. A node of the nodes may represent the data processing system of the data processing systems. The node may include the attributes of a profile of the data processing system. The profile may include, for the each of the data processing systems, attributes such as (i) device information (e.g., a chassis identification, a port identification, a system name, etc.), (ii) network information (e.g., at least one interface name, at least one virtual local area network, a media access control address, etc.), (iii) configuration information (e.g., at least one central processing unit specification, at least one memory capacity, at least one storage capacity, etc.), and/or any other information.

The data processing system may also maintain a copy of a similarity map that defines at least a portion of the similarity groups of the system. Each similarity map may be a local view of a similarity between data processing systems in the portion of similarity groups. The similarity map may include a chart of data processing systems of the distributed system. For example, for each data processing system on the chart, the similarity map may include a profile of the data processing system and/or information related to other profiles of other data processing systems in the respective similarity group.

Additionally, the data processing system may host any number and/or types of agents (e.g., software agents) that may be configured to provide functionalities (e.g., collect data, communicate with other agents, invoke actions, etc.).

To identify that the data processing system has drifted from the original state, operation of the data processing system may be monitored, using a first agent (e.g., tasked with detecting anomalies) hosted by the data processing system, to make an initial conclusion that the data processing system has drifted from the original state. For example, to make the conclusion, the first agent may prompt a trained machine learning model (e.g., a large language model) based on operational data to identify a deviation between data processing system and other data processing systems in the similarity group and/or based on the knowledge graph. The data processing system may subsequently collaborate, using the first agent and a second agent hosted by a second data processing system (e.g., 100B) to verify the initial conclusion to make the identification. The second data processing system may be selected based on the copy of the similarity map hosted by the first data processing system.

Once identified that the data processing system has drifted, the data processing system may be reclassified to a different similarity group (e.g., that may be used to provide more desirable and/or relevant computer-implemented services). To reclassify the data processing system, a third agent hosted by data processing system 100A may collaborate with a fourth agent hosted by another data processing system (e.g., 100B, 100C, etc.) to analyze the new state of the data processing system 100A to obtain an analysis result. For example, the third agent may obtain information from the fourth agent (e.g., a copy of the knowledge graph maintained by the other data processing system), prompt a large language model using the information and the copy of the knowledge graph maintained by data processing system 100A, obtain a result indicating a different similarity group more suitable for data processing system 100A, and/or perform any other processes.

By doing so, the data processing system may perform a management process to update operation of the data processing system using the different similarity group. The management process may include, for example, identifying a level of autonomy for an operation to be performed by the data processing system, identifying a second data processing system to collaborate with to identify a process to perform to update operation of the data processing system, and performing the process to update operation of the data processing system. The level of autonomy may indicate, for example, a quantity of data processing systems impacted by the process (e.g., higher level of impact may require more data processing systems involved in the collaboration and/or decision making).

The data processing system may subsequently obtain information usable to update operation of the data processing system. For example, as a result of the collaboration, the data processing system may perform a process that may include: (i) reallocating central processing unit (CPU) and/or memory resources of the data processing system, (ii) identifying and/or terminating a process that consumes excessive CPU resources, (iii) using a load balancer to evenly distribute at least one request to the data processing system, (iv) restarting at least one service, (v) deleting at least one log and/or clearing a disk cache to free up storage space, and/or performing any other actions to remediate an anomaly detected by the data processing system. By doing so, a quality of computer-implemented services provided by the data processing system may be improved.

To provide the above noted functionality, the system may include data processing systems 100, and management system 102. Each of these components is discussed below.

Data processing systems 100 may include any number of data processing systems (e.g., 100A-100N) that may provide at least a portion of the computer-implemented services (e.g., to users of data processing system 100). To do so, each data processing system (e.g., 100A-100N) of data processing systems 100 may host applications and/or computer-implemented models (e.g., large language models, generative artificial intelligence models, etc.) that provide these (and/or other) computer-implemented services. The applications and/or computer-implemented models may be hosted by one or more of data processing systems 100A-100N. For example, the applications may utilize (e.g., invoke use of, etc.) one or more backend components (e.g., the computer-implemented models, policies, backend applications, data and infrastructures, etc.) to provide the computer-implemented services.

Management system 102 may provide management services (e.g., for data processing systems 100). Management system 102 may include another data processing system configured as a centralized processing entity. For example, to provide the management services, management system 102 may be configured to receive data (e.g., telemetry data) from at least a portion of data processing systems 100 in order to manage system health, application and/or other software related deployments, physical deployments, updates, anomaly detection, anomaly analysis, anomaly resolution, and/or other similar services for data processing systems 100.

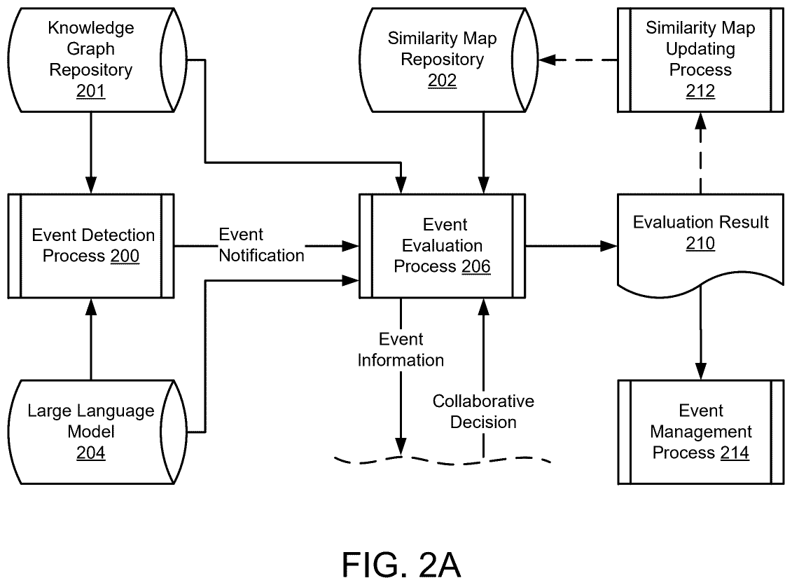

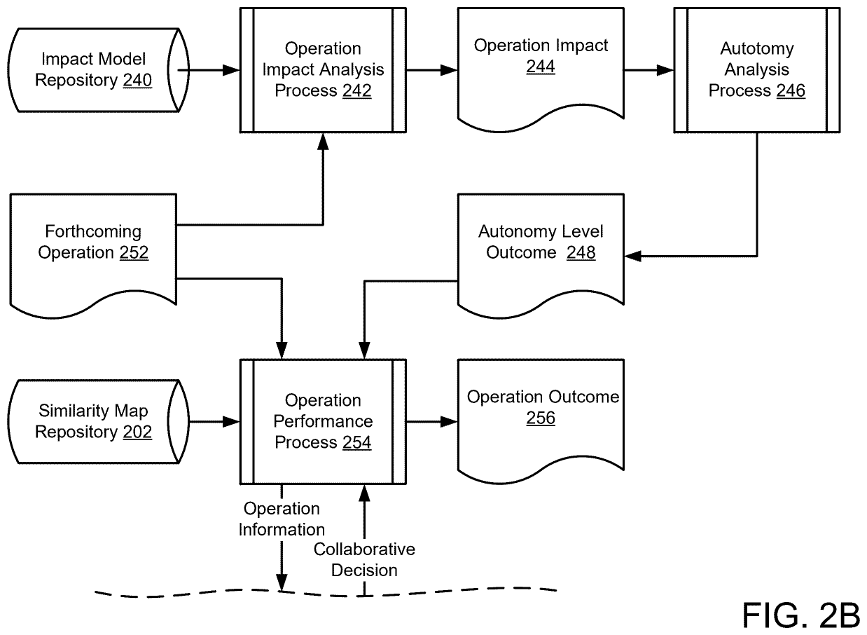

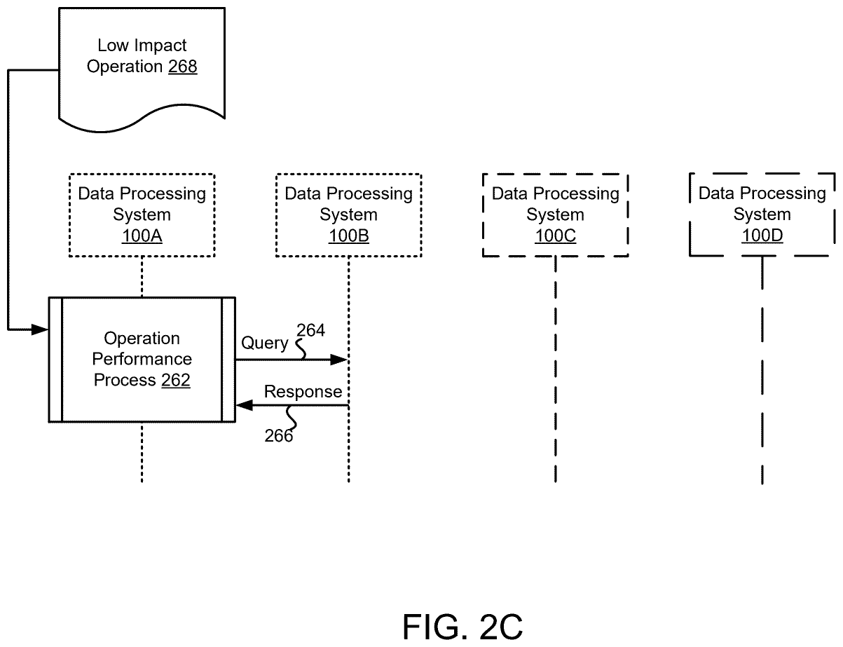

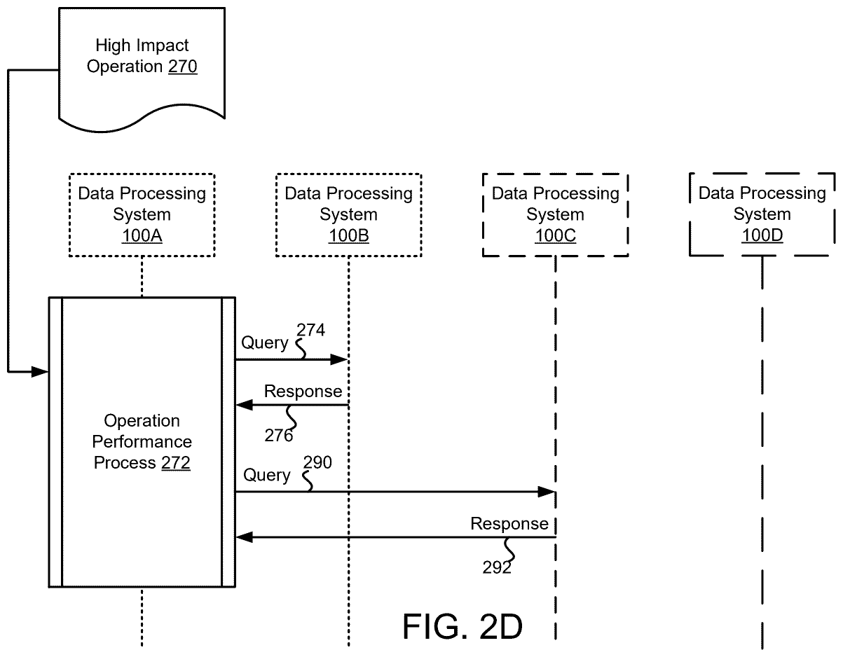

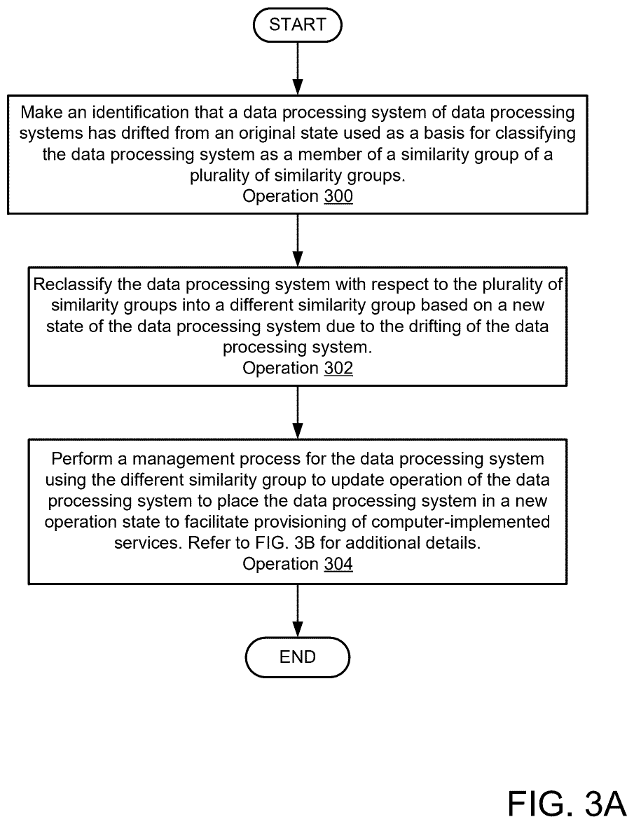

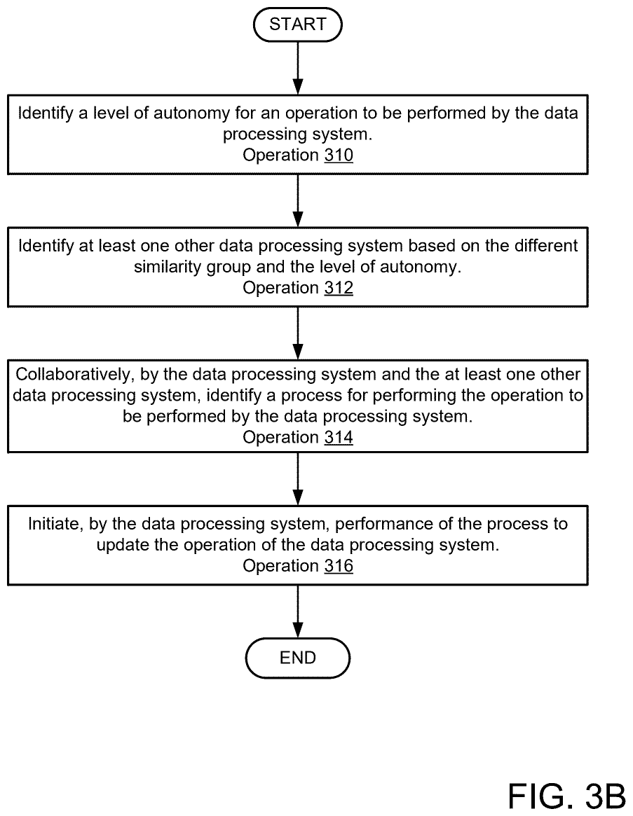

While providing their functionality, any of data processing systems 100 and/or management system 102 may provide all or a portion of the methods shown in FIGS. 2A-3B.

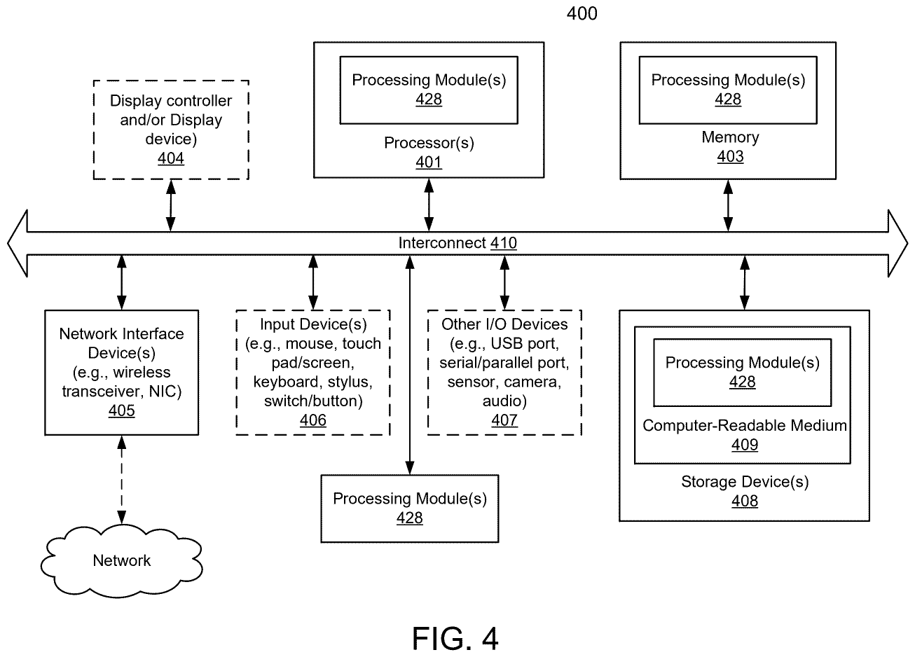

Communication system 104 may allow any of data processing systems 100, and management system 102 to communicate with one another (and/or with other devices not illustrated in FIG. 1). To provide its functionality, communication system 104 may be implemented with one or more wired and/or wireless networks. Any of these networks may be a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may manage operation of a distributed system comprising data processing systems. By classifying the data processing systems into similarity groups and maintaining local copies of knowledge graphs, a portion of the data processing systems may collaborate with other data processing systems in a similarity group to improve computer-implemented services provided by the portion data processing systems.

While illustrated in FIG. 1 with a limited number of specific components, a system may include additional, fewer, and/or different components without departing from embodiments disclosed herein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 210, 244, etc.) is used to represent data structures, a second set of shapes (e.g., 200, 206, etc.) is used to represent processes performed using and/or that generate data, and a third set of shapes (e.g., 201, 202, etc.) is used to represent large scale data structures such as databases.

Turning to FIG. 2A, a first data flow diagram in accordance with an embodiment is shown. The first data flow diagram may illustrate data used in and data processing performed in managing operation of a data processing system with respect to similarity groups based on identification of an event impacting the data processing system.

To manage operation of a data processing system (e.g., 100A), event detection process 200 may be performed. During event detection process 200, an identification may be made that the data processing system has drifted from an original state. For example, the identification may be made by: (i) monitoring, using an agent (e.g., a software agent tasked with analyzing operational data generated by data processing system 100A) hosted by data processing system 100A, (ii) obtaining information from a copy of a knowledge graph stored in knowledge graph repository 201, (iii) comparing the operational data to the information from the knowledge graph, (iv) prompting large language model 204 based on the operational data and the knowledge graph to identify deviations (e.g., between operation of data processing system 100A and operation of other data processing systems indicated by the knowledge graph and/or an original state of data processing system 100A), and/or performing any other actions to make an initial conclusion that data processing system 100A has drifted from the original state.

In addition, data processing system 100A (e.g., the agent hosted by data processing system 100A) may collaborate with other data processing systems (e.g., 100B, 100C, etc.) to verify the initial decision. For example, the agent may communicate with other agents hosted by the other data processing systems to obtain respective copies of knowledge graphs, and re-prompt large language model 204 using information from the other copies of the knowledge graphs to verify the initial conclusion. Once verified, an event notification (e.g., an indication that an anomaly has been detected) may be provided to a second agent hosted by data processing system 100A.

Large language model 204 may include any number and/or type of information regarding a machine learning model adapted to provide an inference based on information provided by a knowledge graph, similarity map, operation data, etc. For example, large language model 204 may include a machine learning architecture (e.g., a neural network framework, an artificial intelligence model, etc.), a set of parameters (e.g., weights, layers, nodes, etc.) to implement a large language model, and/or any other information. Large language model 204 may be prompted to identify and/or generate information relevant to identifying whether operation of data processing system has drifted, classifying a data processing system with respect to similarity groups, and/or any other applications.

To obtain an evaluation result relevant to reclassification of data processing system 100 with respect to similarity groups, event evaluation process 206 may be performed. During event evaluation process 206, data processing system 100A may collaborate with other data processing systems to analyze the event notification, and membership of data processing system 100A with respect to similarity groups may be evaluated. For example, to collaborate with the other data processing systems, (i) data processing system 100A may identify the other data processing systems based on a similarity map obtained from similarity map repository 202, (ii) transmit information (e.g., event logs, performance metrics, etc.) to the identified data processing systems, (iii) reach at least one collaborative decision with the identified processing systems (e.g., 100B, etc.), and/or performing any other actions.

Based on the collaborative decision, data processing system 100A may obtain evaluation result 210. To obtain evaluation result 210, agents hosted by data processing system 100A and/or other data processing systems may (i) obtain information from a copies of respective knowledge graphs stored in knowledge graph repository 201, (ii) obtain information from copies of respective similarity maps stored in similarity map repository 202, (iii) prompt large language model 204 based on copies of the knowledge graph and/or the similarity map to identify a different similarity map that may be more suitable for data processing system 100A, (iv) iteratively transfer information (e.g., obtained as a result of prompting large language model 204) between the agents, and/or perform any other actions.

Evaluation result 210 may indicate whether data processing system 100A is to be reclassified to a different similarity group, information regarding the different similarity group (e.g., configuration information, a process to perform to provision operation of the data processing system with respect to the different similarity group, etc.), and/or any other information. Evaluation result 210 may be a result of a reaching a consensus indicated by the collaborative decision. Once obtained, evaluation 210 result may be used in updating at least a copy of the similarity map to indicate membership of the data processing system in the different similarity group and/or used in performing a management process.

To perform the management process, event management process 214 may be performed. During event management process 214, an operation may be performed to update operation of data processing system 100A. For example, to perform the operation, (i) the operation may be identified based on evaluation result 210 (e.g., to position data processing system 100A in a different similarity group), (ii) a level of autonomy for the operation may be identified, (iii) at least one other data processing system may be identified based on the similarity map, (iv) a process may be collaboratively, between data processing system 100A and the at least one other data processing system, identified, and/or any other actions may be performed. Refer to FIG. 2B for additional details regarding performing the process to update operation of the data processing system.

In an instance where evaluation result 210 indicates that data processing system 100A is to be reclassified to a different similarity group (data flow shown in long-dashed lines), similarity map updating process 212 may be performed. During similarity map updating process 212, at least one copy of a similarity map may be updated based on the reclassification of data processing system 100A. For example, to update the at least one copy of the similarity map, (i) data processing system 100A may modify the copy of the similarity map to reposition a node corresponding to data processing system 100A and/or modify edges connected to the node, (ii) store the modified copy of the similarity map in similarity map repository 202, (iii) exchange copies of similarity maps with other data processing systems to obtain copies of the similarity maps corresponding to different local views of the distributed system, and/or any other processes. By doing so, similarity map repository 202 may be updated following reclassification of a data processing system.

Thus, using the data flow shown in FIG. 2A, operation of a data processing system may be updated collaboratively with at least one other data processing system based on reclassification of the data processing system using a knowledge graph and a similarity map. By doing so, an event that may negatively affect the data processing system may be effectively managed while operating in the updated state.

Turning to FIG. 2B, a second data flow diagram in accordance with an embodiment is shown. The second data flow diagram may illustrate data used in and data processing performed in performing, in a collaboration by at least two data processing systems, an operation.

To perform the operation, operation impact analysis process 242 may be performed. During operation impact analysis process 242, a forthcoming operation (e.g., 252) may be considered for performance by a data processing system (e.g., 100). The forthcoming operation (e.g., 252) may include (i) migrating data from a local database to a cloud database, (ii) developing a new machine learning model for at least one predictive analysis, (iii) utilizing a new data backup and recovery strategy, etc.

Depending on at least one detail of the forthcoming operation (e.g., 252), an impact model may be obtained from an impact model repository (e.g., 240). The impact model may, for example, (i) evaluate an impact of the forthcoming operation on, for example, speed and/or capacity of a data processing system that performs the forthcoming operation, (ii) evaluate the impact of adding more data processing systems to perform with an increased workload by the forthcoming operation, (iii) evaluate an impact on security of at least one data processing system that performs the forthcoming operation, etc.

During operation impact analysis process 242, after at least one impact model has been obtained from the impact model repository (e.g., 240) and/or the forthcoming operation (e.g., 252) has been selected by an administrator, the data processing system (e.g., 100A), a user, etc., an impact analysis may be performed. To perform the impact analysis, at least one simulation may be conducted by the data processing system (e.g., 100A) with the impact model. The simulation may ingest the forthcoming operation (e.g., 252), as well as historical data and/or current data that can be used in the forthcoming operation (e.g., 252). Further, at least one parameter (throughput, latency, response time, at least one resource, etc.) may be adjusted to vary an operation impact (e.g., 244)

The operation impact (e.g., 244) may be generated by the impact model. The outcome impact (e.g., 244) may include at least one measurable effect of performing the forthcoming operation (e.g., 252) by the data processing system (e.g., 100A). Specific examples of the at least one measure effect may include (i) a measure of greenhouse gas emission, energy consumption, waste generation, etc. in a manufacturing operation, (ii) revenue change, cost savings, profit margin, etc. in a financial operation, (iii) system uptime, error frequency, new product development rates, etc. of a new technology, etc.

The operation impact (e.g., 244) may include short-term effects and/or long-term effects that occur during the forthcoming operation (e.g., 252). The short-term effects may appear at any time during the forthcoming operation (e.g., 252) and/or disappear within a short period of time. The long-term effects may appear at any time during the forthcoming operation (e.g., 252) and/or persist for a long period of the time. The short-term effects and/or the long-term effects may contribute to any variation in the operation impact (e.g., 244).

Based on the at least one measurable effect and/or the short-term effects and/or long-term effects of the operation impact (e.g., 244) autonomy analysis process 246 may be performed. During autonomy analysis process 246, an autonomy model may ingest the operation impact (e.g., 244) to determine an autonomy level outcome (e.g., 248). The autonomy level outcome (e.g., 248) may include a level of the autonomy that can be identified by granting, by an autonomy model, a measure of discretion to the data processing system (e.g., 100A) in a performance of the forthcoming operation. The measure of discretion may include a less autonomous (e.g., command-driven), a partially autonomous (e.g., consensus-based), a more autonomous (e.g., self-directed), etc. performance of the forthcoming operation (e.g., 252) by the data processing system (e.g., 100A). With the measure of the discretion, the autonomy model may direct how the data processing system (e.g., 100A) may collaborate with at least one other data processing system (e.g., 100B, etc.) of the deployment.

During autonomy analysis process 246, the autonomy model may determine the autonomy level outcome (e.g., 248) by assessing a magnitude (e.g., high, low, moderate, etc.) of the operation impact (e.g., 244). Based on the magnitude, the autonomy model may, using the autonomy level outcome (e.g., 248), direct how the data processing system (e.g., 100A) may collaborate with at least one other data processing system during operation performance process 254.

The autonomy model may direct how the data processing system (e.g., 100A) may collaborate by guiding the data processing system (e.g., 100A) in a selection of, using a similarity map a similarity map repository (e.g., 202), the at least one other data processing system (e.g., 100B, etc.) based on a measure of similarity between the data processing system (e.g., 100A) and the at least one other data processing system (e.g., 100B). If the forthcoming operation (e.g., 252) has a low impact level (i.e., from the operation impact (e.g., 244)), the autonomy model may enable the data processing system (e.g., 100A) to select the at least one other data processing system (e.g., 100B, etc.) that is mostly similar to the data processing system (e.g., 100A). However, if the forthcoming operation has a high impact level (i.e., from the operation impact (e.g., 244)), the autonomy model may enable the data processing system (e.g., 100) to select the at least one other data processing system (e.g., 100B, etc.) that is similar and/or dissimilar to the data processing system (e.g., 100).

Selecting, by the data processing system (e.g., 100A), the at least one other data processing system (e.g., 100B, etc.) that is similar and/or dissimilar may enable the data processing system (e.g., 100A) to, for example, (i) learn a diverse approach to performing the forthcoming operation, (ii) utilize different resources to perform the forthcoming operation, etc. The data processing system (e.g., 100A) may, for example, (i) learn the diverse approach, (ii) utilize the different resources, etc. by (i) passing operation information to the at least one other data processing system (e.g., 100B, etc.) and/or (ii) reaching at least one collaborative decision with the at least one other data processing system (e.g., 100B, etc.).

In a collaboration with the at least one other data processing system (e.g., 100B, etc.) for performance of the forthcoming operation (e.g., 252), operation outcome (e.g., 256) may be generated. The operation outcome (e.g., 256) may include the at least one measurable effect (which may be included in the operation impact (e.g., 244)) and/or at least one result of performing the forthcoming operation (e.g., 252) by the data processing system (e.g., 100) and/or the at least one other data processing system (e.g., 100B, etc.). However, by performing the forthcoming operation (e.g., 252) in the collaboration, the at least one measurable effect (from the operation impact (e.g., 244)), at least one short-term effect and/or at least one long-term effect of the forthcoming operation (e.g., 252) may not be observed.

The at least one measurable effect (from the operation impact (e.g., 244)), the at least one short-term effect and/or the at least one long-term effect may not be observed because the collaboration may have resulted in a new approach to performing the forthcoming operation (e.g., 252).

For example, a first data processing system (e.g., 100A) may perform spam detection of incoming e-mails for a business using certain keywords. However, an approach using basic keyword detection to filter e-mails may incorrectly flag and/or trash legitimate e-mails, which can have a measurable impact on commerce in a business that uses the first data processing system (e.g., 100A).

To enable for more accurate spam detection of the e-mails, a second data processing system (e.g., 100B) may be used. The second data processing system (e.g., 100B), selected from the similarity map, may be used by (i) receiving a flagged e-mail from the first data processing system (e.g., 100) and (ii) sending the flagged e-mail to a trained inference model to generate an output. The output may include a determination of whether the flagged e-mail is spam. Further, the second data processing system (e.g., 100B) may use historical e-mails, already determined to be spam, to train and/or update the inference model.

Thus, via the third data flow illustrated in FIG. 2C, a system in accordance with an embodiment may perform, in the collaboration by the at least two data processing systems, the operation. Consequently, the data processing system (e.g., 100) may be more likely to be able to provide desired computer-implemented services by leveraging combined computational resources of data processing systems.

To further clarify embodiments disclosed herein, interactions diagrams in accordance with an embodiment are shown in FIGS. 2C-2D. These interactions diagrams may illustrate how data may be obtained and used within the system of FIG. 1.

In the interaction diagrams, processes performed by and interactions between components of a system in accordance with an embodiment are shown. In the diagrams, components of the system are illustrated using a first set of shapes (e.g., 100A, 100B, etc.), located towards the top of each figure. Lines descend from these shapes. Processes performed by the components of the system are illustrated using a second set of shapes (e.g., 262, 272, etc.) superimposed over these lines. Interactions (e.g., communication, data transmissions, etc.) between the components of the system are illustrated using a third set of shapes (e.g., 264, 266, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 264 may occur prior to the interaction labeled as 266. However, it will be appreciated that the processes and interactions may be performed in different orders, any may be omitted, and other processes or interactions may be performed without departing from embodiments disclosed herein.

Turning to FIG. 2C, a first interaction diagram in accordance with an embodiment is shown. The first interaction diagram may illustrate data used in and data processing performed in collaborating, by two data processing systems (e.g., 100A, 100B, etc.), to perform a low impact operation (e.g., 268).

To perform the low impact operation (e.g., 268), operation performance process 262 may be performed. During operation performance process 262, at least one task of a low impact operation (e.g., 268) may be performed by a first data processing system (e.g., 100A) and/or a second data processing system (e.g., 100B). The at least one task may be included in the low impact operation because the at least one task may consume minimal resources (e.g., memory, storage, etc.) of a system, have a negligible operation impact (e.g., 244) on a functionality of the system, etc.

Because the at least one task may consume minimal resources (e.g., the memory, the storage, etc.), have the negligible operation impact (e.g., 244), etc., performance of the at least one task may be assigned to the first data processing system (e.g., 100A) and/or the second data processing system (e.g., 100B). An assignment of the first data processing system (e.g., 100A) and/or the second data processing system (e.g., 100B) may be performed using a similarity map and/or at least one autonomy model.

According to the similarity map, the first data processing system (e.g., 100A) may have first attributes that may be similar to second attributes of the second data processing system (e.g., 100B). As a result of the similarity between the first attributes and the second attributes, the at least one autonomy model may direct the first data processing system (e.g., 100A) to collaborate with the second data processing system (e.g., 100B). Therefore, using the first attributes of the first data processing system (e.g., 100A) and the second attributes of the second data processing system (e.g., 100B), each data processing system may (i) learn a less diverse approach to performing the low impact operation (e.g., 268), (ii) utilize similar resources to perform the low impact operation (e.g., 268), etc.

Using an example from the description of FIG. 2C, the first data processing system (e.g., 100A) may perform spam detection of incoming e-mails for a business using certain keywords. However, an approach using basic keyword detection to filter e-mails may incorrectly flag and/or trash legitimate e-mails, which can have a measurable (e.g., a low, in this case) impact on commerce in a business that uses the first data processing system (e.g., 100A).

To enable for more accurate spam detection of the e-mails, a second data processing system (e.g., 100B) may be used. The second data processing system (e.g., 100B), selected from the similarity map, may be used by (i) receiving (e.g., 264) a flagged e-mail from the first data processing system (e.g., 100A) and (ii) sending the flagged e-mail to a trained inference model to generate an output. The output may include a determination of whether the flagged e-mail is spam. The output may be sent (e.g., 266) from the second data processing system (e.g., 100B) to the first data processing system (e.g., 100A). Further, the second data processing system (e.g., 100B) may use historical e-mails, already determined to be spam, to train and/or update the inference model.

Thus, via the first interaction illustrated in FIG. 2C, a system in accordance with an embodiment may collaborate, by two data processing systems (e.g., 100, 100B, etc.), to perform the low impact operation (e.g., 268). Consequently, the data processing system (e.g., 100A) may be more likely to be able to provide desired computer-implemented services by leveraging combined computational resources of few data processing systems (e.g., 100, 100B, etc.) with similar attributes.

Turning to FIG. 2D, a second interaction diagram in accordance with an embodiment is shown. The second interaction diagram may illustrate data used in and data processing performed in collaborating, by three data processing systems (e.g., 100, 100B, 100C etc.), to perform a high impact operation (e.g., 270).

To perform the high impact operation (e.g., 270), operation performance process 272 may be performed. During operation performance process 272, at least one task of a high impact operation (e.g., 270) may be performed by a first data processing system (e.g., 100A), a second data processing system (e.g., 100B), and/or a third data processing system (e.g., 100C). The at least one task may be included in the high impact operation (e.g., 270) because the at least one task may consume significant resources (e.g., memory, storage, etc.) of a system, have a substantial operation impact (e.g., 244) on a functionality of the system, etc.

Because the at least one task may consume significant resources (e.g., the memory, the storage, etc.), have the substantial operation impact (e.g., 244), etc., performance of the at least one task may be assigned to the first data processing system (e.g., 100A), the second data processing system (e.g., 100B), and/or the third data processing system (e.g., 100C). An assignment of the first data processing system (e.g., 100A), the second data processing system (e.g., 100B), and/or the third data processing system (e.g., 100C) may be performed using a similarity map and/or at least one autonomy model.

According to the similarity map, the first data processing system (e.g., 100A) may have first attributes that may be similar to second attributes of the second data processing system (e.g., 100B). As a result of the similarity between the first attributes and the second attributes, the at least one autonomy model may direct the first data processing system (e.g., 100A) to collaborate with the second data processing system (e.g., 100B). Therefore, using the first attributes of the first data processing system (e.g., 100A) and the second attributes of the second data processing system (e.g., 100B), each data processing system may (i) learn a less diverse approach to performing the high impact operation (e.g., 270), (ii) utilize similar resources to perform the high impact operation (e.g., 270), etc.

Likewise, according to the similarity map, the first data processing system (e.g., 100A) may have the first attributes that may be dissimilar from third attributes of the third data processing system (e.g., 100C). As a result of the dissimilarity between the first attributes and the third attributes, the at least one autonomy model may direct the first data processing system (e.g., 100A) to also collaborate with the third data processing system (e.g., 100C). Therefore, using the first attributes of the first data processing system (e.g., 100A) and/or the third attributes of the third data processing system (e.g., 100C), each data processing system may (i) learn a more diverse approach to performing the high impact operation (e.g., 270), (ii) utilize different resources to perform the high impact operation (e.g., 270), etc.

For example, the high impact operation (e.g., 270) may include fraud detection in at least one financial transaction. To perform the fraud detection, the first data processing system (e.g., 100A), the second data processing system (e.g., 100B), and/or the third data processing system (e.g., 100C) may collaborate during operation performance process 272.

During operation performance process 272, the first data processing system (e.g., 100A) may collect transaction data from at least one automated telling machines (ATM), at least one point-of-sale system, at least one online banking platform, etc. The first data processing system (e.g., 100A) may send (e.g., 274) the transaction data to the second data processing system (e.g., 100B). The second data transaction system (e.g., 100B) may receive the transaction data and/or use rule-based algorithms to analyze the transaction data for at least one fraud pattern (e.g., multiple transactions in quick succession, large cash withdrawals, etc.) to generate flagged transaction data. The second data processing system (e.g., 100B) may send (e.g., 276) the flagged transaction data to the first data processing system (e.g., 100A).

Upon receiving the flagged transaction data, the first data processing system (e.g., 100A) may send (e.g., 290) the flagged transaction data to the third data processing system (e.g., 100C). The third data transaction system (e.g., 100C) may receive the flagged transaction data and send the flagged transaction data to a trained machine learning model. The trained machine learning model may ingest the flagged transaction data and generate the output. The output may include at least one detailed risk score and/or at least one insight into the flagged transaction data. The third data transaction system (e.g., 100C) may receive the output from the trained machine learning model and send (e.g., 292) the output to the first data processing system (e.g., 100A). Upon receiving the output, the first data processing system (e.g., 100A) may ingest the output and generate, based on the output, at least one action. The at least one action may include (i) altering at least one customer, (ii) blocking at least one fraudulent transaction, (iii) notifying at least one law enforcement agency, etc.

Thus, via the second interaction illustrated in FIG. 2D, a system in accordance with an embodiment may collaborating, by the three data processing systems (e.g., 100, 100B, 100C, etc.), to perform the high impact operation (e.g., 270). Consequently, the data processing system (e.g., 100A) may be more likely to be able to provide desired computer-implemented services by leveraging combined computational resources of more data processing systems (e.g., 100A, 100B, 100C, etc.).

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing operation of a distributed system comprising data processing systems in accordance with an embodiment is shown. The method may be performed, for example, by any of the components of the system of FIG. 1, and/or other components not shown therein.

At operation 300, an identification may be made that a data processing system of the data processing systems has drifted from an original state used as a basis for classifying the data processing system as a member of similarity group of a plurality of similarity groups. The identification may be made by: (i) monitoring operation of the data processing system using a software agent hosted by the data processing system to obtain operational data, (ii) detecting an anomaly in the operational data relative to historical data, (iii) prompting a large language model to identify deviations in the operational data based on a knowledge graph, and/or via any other processes.

At operation 302, the data processing system may be reclassified with respect to the plurality of similarity groups into a different similarity group based on a new state of the data processing system due to the drifting of the data processing system. The data processing system may be reclassified by: (i) passing enriched knowledge graph data to other data processing systems via agents hosted by each of the data processing systems, (ii) performing a voting process with the other data processing systems to decide whether the data processing system is to be reclassified based on the operational data, (iii) utilizing a threshold based on a context and/or severity of the drift of the data processing system, and via any other processes.

At operation 304, a management process may be performed for the data processing system using the different similarity group to update operation of the data processing system to place the data processing system in a new operation state to facilitate provisioning of computer-implemented services. The management process may be performed by: (i) identifying a level of autonomy of an operation to be performed by the data processing system, (ii) identifying at least one other data processing system based on the different similarity group, (iii) collaboratively identifying and/or performing a process to update operation of the data processing system, and/or performing any other actions. Refer to FIG. 3B for additional details regarding performing the management process.

The method may end following operation 304.

Using the method shown in FIG. 3A, operation of data processing systems in a distributed system may be managed by reclassifying a data processing system with respect to similarity groups when the data processing system is identified to have drifted. While operating in a different similarity group, the data processing system may be more likely to provide desired computer-implemented services.

Turning to FIG. 3B, a second flow diagram illustrating a method of performing a management process in accordance with an embodiment is shown. The method may be performed, for example, by any of the components of the system of FIG. 1, and/or other components not shown therein.

At operation 310, a level of autonomy may be identified for an operation to be performed by the data processing system. The level of autonomy may be identified by: (i) assessing a magnitude (e.g., high, low, moderate, etc.) of an impact of the operation relative to the distributed system, (ii) performing a risk analysis for the operation, and/or via any other processes.

At operation 312, at least one other data processing system may be identified based on the different similarity group and the level of autonomy. The at least one other data processing system may be identified by: (i) performing a similarity search using a copy of the similarity map, (ii) identifying neighboring nodes in the similarity map based on labeled clusters of nodes, (iii) prompting a large language model based on the similarity map to identify the at least one data processing system that may be most suitable with which to collaborate, and/or via any other processes.

At operation 314, a process may be collaboratively identified by the data processing system and the at least one other data processing system. The process may be collaboratively identified by: (i) exchanging data (e.g., telemetry data) relevant to operation of the data processing system, (ii) generating inferences for performance of the data processing system with respect to the process, (iii) performing a root-cause analysis using a knowledge graph and data relevant to the drift of the data processing system (e.g., performance metrics, error logs, etc.), and/or performing any other actions.

At operation 316, performance of the process may be initiated to update operation of the data processing system. The performance of the process may be initiated by: (i) redistributing workloads for the data processing system based on load balancing, (ii) invoking a remediation process to update a configuration of the resources hosted by the data processing system, (iii) enforcing compliance of the data processing system with rules specified by the different similarity group, and/or via any other process.

The method may end following operation 316.

Using the method shown in FIG. 3B, a management process may be collaboratively performed to update operation of the data processing system based on a different similarity group. By doing so, the data processing system may provide computer-implemented services by leveraging information provided by data processing systems in the different similarity group.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a distributed system comprising data processing systems, the method comprising:
making an identification that a data processing system of the data processing systems has drifted from an original state used as a basis for classifying the data processing system as a member of a similarity group of a plurality of similarity groups;
based on the identification:
reclassifying the data processing system with respect to the plurality of similarity groups into a different similarity group of the plurality of similarity groups based on a new state of the data processing system due to the drifting of the data processing system; and
performing a management process for the data processing system using the different similarity group to update operation of the data processing system to place the data processing system into a new operation state to facilitate provisioning of computer-implemented services.

2. The method of claim 1, wherein each of the data processing systems maintains a copy of a knowledge graph of a condition of the distributed system, each knowledge graph being a local view of the distributed system.

3. The method of claim 2, wherein each of the data processing systems exchange information with neighboring data processing systems to construct respective copies of the knowledge graph.

4. The method of claim 2, wherein each of the data processing systems maintains a copy of a similarity map that defines at least a portion of the plurality of similarity groups, each similarity map being a local view of similarity between the data processing systems.

5. The method of claim 4, wherein making the identification comprises:
monitoring, by a first agent hosted by the data processing system, operation of the data processing system to make an initial conclusion that the data processing system has drifted from the original state; and
collaboratively, by the first agent and with at least one other agent hosted by another of the data processing systems selected on a basis of a copy of the similarity map maintained by the data processing system, verifying the initial conclusion to make the identification.

6. The method of claim 5, wherein making the identification comprises:
prompting a trained machine learning model based on at least a portion of the knowledge graph.

7. The method of claim 4, wherein reclassifying the data processing system with respect to the plurality of similarity groups into the different similarity group of the plurality of similarity groups based on the new state of the data processing system due to the drifting of the data processing system comprises:
collaboratively, by at least a first agent hosted by the data processing system and another agent hosted by another of the data processing systems selected on a basis of a copy of the similarity map maintained by the data processing system, analyzing the new state of the data processing system to obtain an analysis result; and
updating clusters of the data processing systems based on the analysis result to place the data processing system into the different similarity group.

8. The method of claim 1, wherein performing the management process comprises:
identifying a level of autonomy for an operation to be performed by the data processing system;
identifying at least one other data processing system based on the different similarity group and the level of autonomy;
collaboratively, by the data processing system and the at least one other data processing system, identifying a process for performing the operation to be performed by the data processing system; and
initiating, by the data processing system, performance of the process to update the operation of the data processing system.

9. The method of claim 1, wherein the data processing system is an edge device among edge devices within a computing infrastructure comprising a centralized processing entity tasked with managing operation of the edge devices, the data processing system being configured to perform the method without interference from the centralized processing entity if the data processing system comprises sufficient computing resources to perform the method.

10. A non-transitory machine-readable medium having instructions stored therein, which when executed by a processor, cause the processor to perform operations for managing operation of a distributed system comprising data processing systems, the operations comprising:
making an identification that a data processing system of the data processing systems has drifted from an original state used as a basis for classifying the data processing system as a member of a similarity group of a plurality of similarity groups;
based on the identification:
reclassifying the data processing system with respect to the plurality of similarity groups into a different similarity group of the plurality of similarity groups based on a new state of the data processing system due to the drifting of the data processing system; and
performing a management process for the data processing system using the different similarity group to update operation of the data processing system to place the data processing system into a new operation state to facilitate provisioning of computer-implemented services.

11. The non-transitory machine-readable medium of claim 10, wherein each of the data processing systems maintains a copy of a knowledge graph of a condition of the distributed system, each knowledge graph being a local view of the distributed system.

12. The non-transitory machine-readable medium of claim 11, wherein each of the data processing systems exchange information with neighboring data processing systems to construct respective copies of the knowledge graph.

13. The non-transitory machine-readable medium of claim 11, wherein each of the data processing systems maintains a copy of a similarity map that defines at least a portion of the plurality of similarity groups, each similarity map being a local view of similarity between the data processing systems.

14. The non-transitory machine-readable medium of claim 13, wherein making the identification comprises:
monitoring, by a first agent hosted by the data processing system, operation of the data processing system to make an initial conclusion that the data processing system has drifted from the original state; and
collaboratively, by the first agent and with at least one other agent hosted by another of the data processing systems selected on a basis of a copy of the similarity map maintained by the data processing system, verifying the initial conclusion to make the identification.

15. The non-transitory machine-readable medium of claim 14, wherein making the identification comprises:
prompting a trained machine learning model based on at least a portion of the knowledge graph.

16. A system, comprising:
a processor; and
a memory coupled to the processor to store instructions, which when executed by the processor, cause the processor to perform operations for managing operation of a distributed system comprising data processing systems, the operations comprising:
making an identification that a data processing system of the data processing systems has drifted from an original state used as a basis for classifying the data processing system as a member of a similarity group of a plurality of similarity groups;
based on the identification:
reclassifying the data processing system with respect to the plurality of similarity groups into a different similarity group of the plurality of similarity groups based on a new state of the data processing system due to the drifting of the data processing system; and
performing a management process for the data processing system using the different similarity group to update operation of the data processing system to place the data processing system into a new operation state to facilitate provisioning of computer-implemented services.

17. The system of claim 16, wherein each of the data processing systems maintains a copy of a knowledge graph of a condition of the distributed system, each knowledge graph being a local view of the distributed system.

18. The system of claim 17, wherein each of the data processing systems exchange information with neighboring data processing systems to construct respective copies of the knowledge graph.

19. The system of claim 17, wherein each of the data processing systems maintains a copy of a similarity map that defines at least a portion of the plurality of similarity groups, each similarity map being a local view of similarity between the data processing systems.

20. The system of claim 18, wherein making the identification comprises:
monitoring, by a first agent hosted by the data processing system, operation of the data processing system to make an initial conclusion that the data processing system has drifted from the original state; and
collaboratively, by the first agent and with at least one other agent hosted by another of the data processing systems selected on a basis of a copy of the similarity map maintained by the data processing system, verifying the initial conclusion to make the identification.
